(19) United States
(12) Patent Application Publication
(10) Pub. No.: US 2009/0160210 A1
(43) Pub. Date: Jun. 25, 2009

(54) VEHICLE WITH A SOFT TOP AND A REAR FLAP

(76) Inventors: Dirk Legler, Weil (DE); Robert Braun, Berg (DE); Rudolf Dietl, Munich (DE)

Correspondence Address: DICKINSON WRIGHT PLLC, 1875 Eye Street, NW, Suite 1200, WASHINGTON, DC, 20006, US

(21) Appl. No.: 11/908,637

(22) PCT Filed: Mar. 15, 2006
(86) PCT No.: PCT/DE06/00460

§ 371 Date: Oct. 23, 2007

(30) Foreign Application Priority Data
Mar. 15, 2005 (DE) 10 2005 012 222.1

(51) Int. Cl. B60J 7/00

(52) U.S. Cl. 296/112

(57) ABSTRACT

The invention relates to a vehicle comprising a folding top (1) that can be adjusted between a closed position and an open position and that has a mobile rear top bow (6), and further comprising a rear flap (8) closing a rear storage space (28). In order to improve functionality, the rear flap (8) is pivoted to the top bow (6). The rear flap (8) can be lifted together with the upward pivoting top bow (6), thereby releasing a larger rear opening (27). The top bow is preferably a fabric-tensioning bow (6) of the folding top (2) that is covered with a folding top fabric.

The invention relates to a vehicle with a folding convertible top which is adjustable between a closed position and an open position and which has a movable rear “top bow” member and a rear flap (also referred to as a rear flap door, or hatchback) which rear flap closes off a rear storage space.

DE 19927237 C1 discloses a vehicle with an openable top and a rear flap, which flap comprises a tailgate swingably mounted at its rear edge against the vehicle body, wherewith to provide access to the rear opening the tailgate is rearwardly swingable. A rear part of the openable top has a material-tensioning bow member at its lower side [sic], which bow can be swung upward in order to provide improved access to a rear storage space when the tailgate is in the down-swung state (FIG. 6 of the cited reference). For reasons of safety, the downwardly swingable tailgate must have a robust support system which provides sufficient strength to avoid damage which is apt to occur when a downwardly swung tailgate is subjected to high loads.

The underlying problem of the present invention was to devise improvements to a vehicle of the type described supra, regarding its functionality and particularly the functionality of its rear flap.

This problem is solved according to the invention, for a vehicle of the type described supra, in that the rear flap door is swingably mounted on the top bow member. The mounting of the rear flap on the top bow member allows the rear flap to be moved upward or downward by raising or lowering said top bow member. When the rear flap is unlocked and in an unopened or partially opened position, the top bow member can be used to move the rear flap upward, to render accessible at least a part of the rear opening of the rear storage space. In general, the top bow member may comprise a rear part of the vehicle top (convertible top, soft top, foldable or retractable top, or the like), which bow member is mounted so as to be movable with respect to the vehicle body, in particular movable vertically upwardly.

Advantageous refinements of the invention are set forth in the dependent claims.

The invention provides a particular advantage in that the rear flap is upwardly movable by means of the upwardly swingable top bow member, such that a rear loading opening of greater height can be made accessible. Thus, when the rear flap is opened (swung upward) to its fullest extent, a vertically substantially larger loading opening can be provided. The simple raising kinematics, wherein the entire structure is raised by the additional distance, allows the additional raising to be carried out with minimal additional manipulation and effort.

Advantageously, the rear flap is swingably mounted on the top bow may means of a support apparatus which apparatus comprises a hinge mechanism, a multi-hinge mechanism, or in particular a quadruple hinge mechanism. Whereas with a single hinge the flap will execute a purely swinging movement, with four or more articulations the desired general swinging movement is more broadly adjustable. The swinging of the rear flap may be solely by manual force, or by manual force mechanically aided by drive means, or solely by drive means.

In order to aid in supporting the top bow and the rear flap mounted on it, support means for the top bow may be provided, in the form of a pressurized gas cylinder (“pneumatic spring”) connected to the vehicle body. This affords reduction in the forces needed for raising and adjusting, which is particularly advantageous in the case of manual raising.

Preferably, the top bow is swingable by means of a drive device, which may comprise a hydraulic cylinder or a motor-driven drive. Additional support in the form of one or more pressurized gas cylinder (“pneumatic springs”) may be provided.

According to a particularly preferred embodiment, the top bow is in the form of a material-tensioning bow associated with the folding convertible top which top has a covering material (e.g. fabric or the like). In general, the top may be a convertible top comprising covering material or may be a folding or otherwise retractable hardtop having rigid curved roof elements. In the latter case, the top bow member may consist of a segment of a rear roof piece, or may comprise an independent movable support piece for the rear flap door.

To lock the rear flap door and the top bow member (material-tensioning bow) in their closed positions, it may provided that, when the rear flap door is closed, a tensile device which connects the rear flap door with the vehicle body is active, serving to hold the top bow (material-tensioning bow) in its closed position. This tensile device may be controlled by the closing movement of the rear flap door and top bow member (material-tensioning bow), e.g. by mechanical means. Thus, when the rear flap door is raised, the tensile device is or becomes inactive, and when the rear flap door is lowered again the tensile device becomes active again.

In a preferred embodiment, the tensile device comprises a tensile cable which is attached to a swing arm which is robustly connected to the rear flap door; and the swing arm is mounted on the rear flap door in a manner such that when the rear flap door is swung upward the tensile cable is relaxed from its tensile active condition and allows up-swinging of the top bow (material-tensioning bow). The tensile cable may be connected to the vehicle body via a tensioning spring, so that the closing force is applied elastically; or the tensile cable itself may have a certain elasticity.

Further, it may be provided that, when the rear flap door is swung into its closed position, a locking member of the rear flap door, which locking member is disposed near the swinging support apparatus of the rear flap door, comes into locking engagement with a holding member which is connected to the vehicle body. This solution provides for reliable locking of the rear flap door and the top bow member (material-tensioning bow).

Advantageously, a closure assist device is provided in conjunction with the rear flap door lock, which closure assist device assists in the closing and locking of the rear flap, and which enhances the operating safety and reliability of the closing and locking process. The active part of the closure assist device may be disposed on the vehicle body or the rear flap, particularly on the rear flap door lock.

Further, the above-described closure assist device, or a separate closure assist device, may assist in the locking of the top bow member (material-tensioning bow) in its closed position; the excursion of this closure assist device may be relatively large. Such locking may be with the aid of the closure assist device, or the closure assist device may comprise the locking means, which locking means may be the sole locking means or may be in addition to other locking means. One or more locks may be provided for locking the top bow member to the vehicle body. Thus, when the top bow member (material-tensioning bow) is lowered into its closed position, a latch member of the lock may automatically engage an accommodating locking member on or in the top bow. Actuating means may be provided for unlocking this lock; advantageously, these actuating means are coupled with the drive device of the top bow member (material-tensioning bow).

The rear flap door may have a low-weight construction, e.g. LFI (long fiber injection), PHC (paper honeycomb), WHC (Webasto honeycomb), SMC (sheet molded compound) (aka sheet molding compound), or LFT (long fiber thermoplastic), thereby reducing the weight of the structure which must be supported and to which a force moment must be applied in the up-swinging and raising.

The rear flap door may be configured such that when the rear flap door is in its closed position it is generally vertically oriented, and closes-off the rear loading opening. However, the rear flap is not limited to such a configuration; e.g. it may have horizontally extending parts. The vehicle is advantageously a “hatchback convertible”, wherewith the rear flap door immediately adjoins the top bow (material-tensioning bow).

The vehicle will be described in more detail hereinbelow on the basis of an exemplary embodiment, with reference to the drawings.

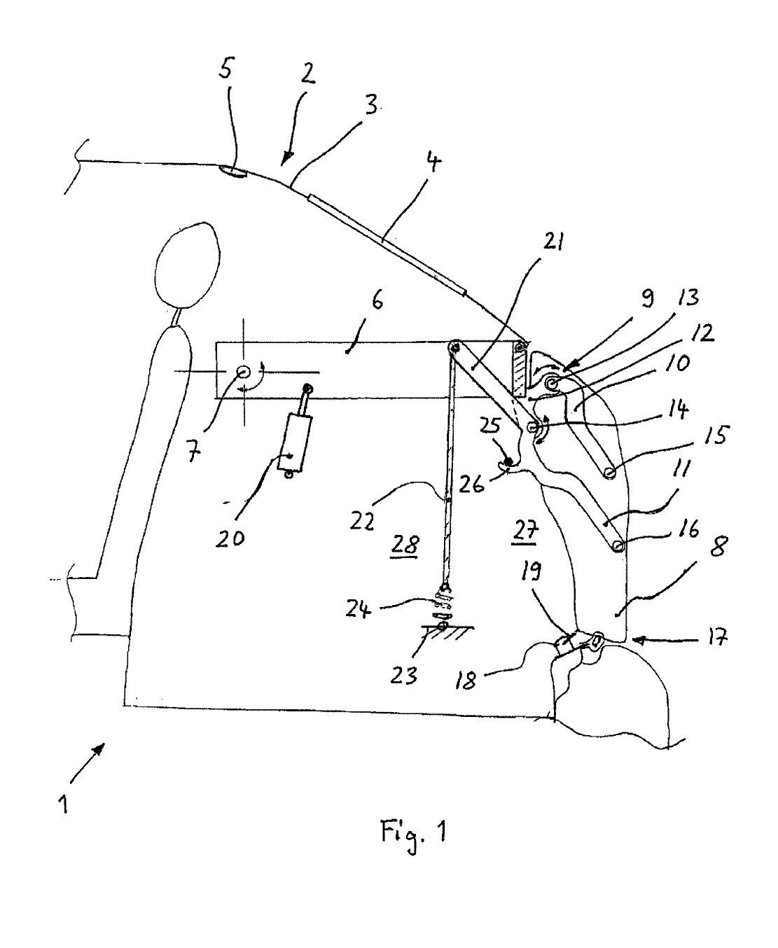

FIG. 1 is a schematic lateral view of a rear region of a vehicle with an openable top, and a rear flap in the closed position, which rear flap is swingably mounted on a material-tensioning bow member;

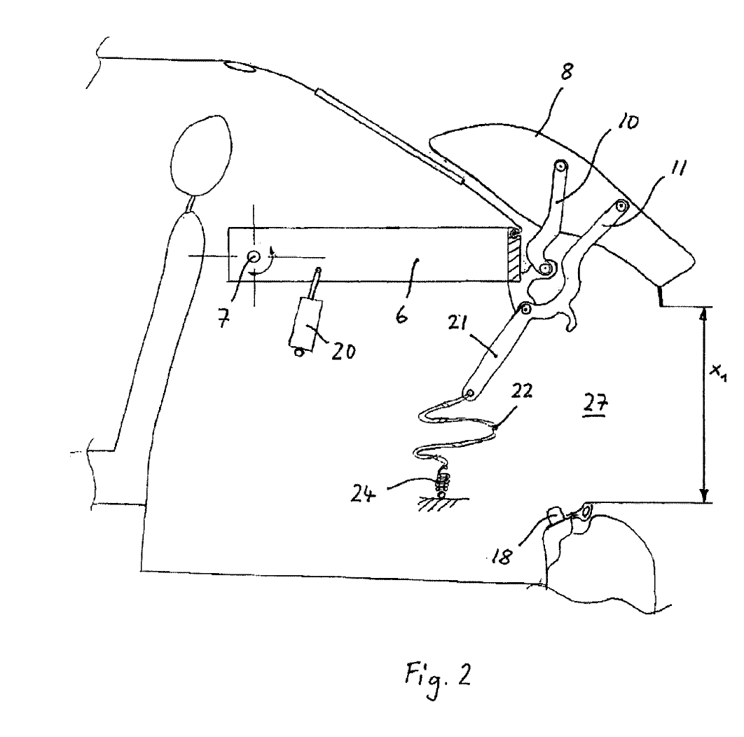

FIG. 2 is a view analogous to FIG. 1, of the rear region of the vehicle with the rear flap in the open position;

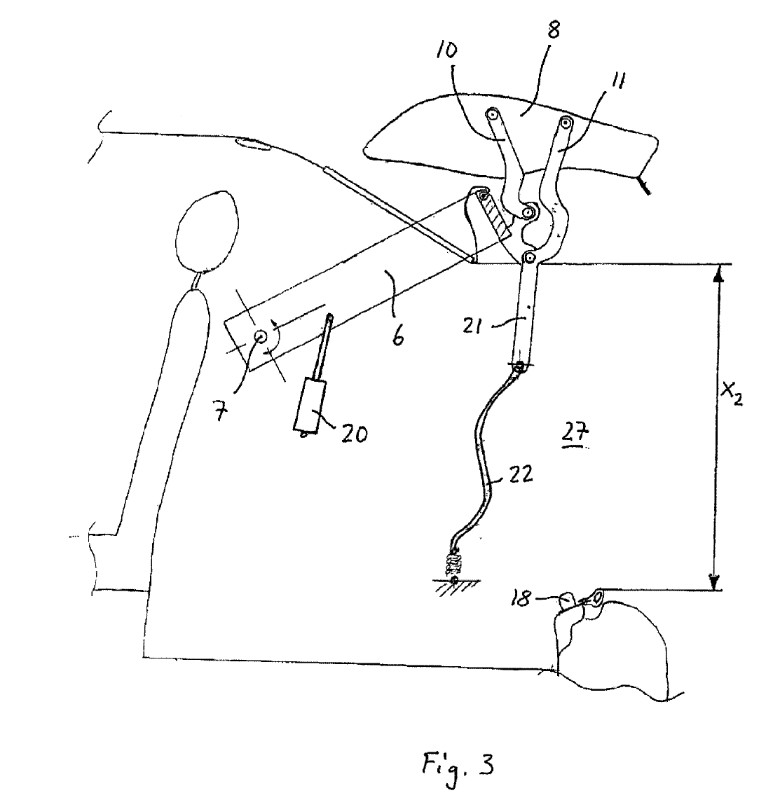

FIG. 3 is a view analogous to FIG. 1, of the rear region of the vehicle with the rear flap in the up-swung position, wherewith the rear flap has been further raised by swinging-up of the material-tensioning bow; and

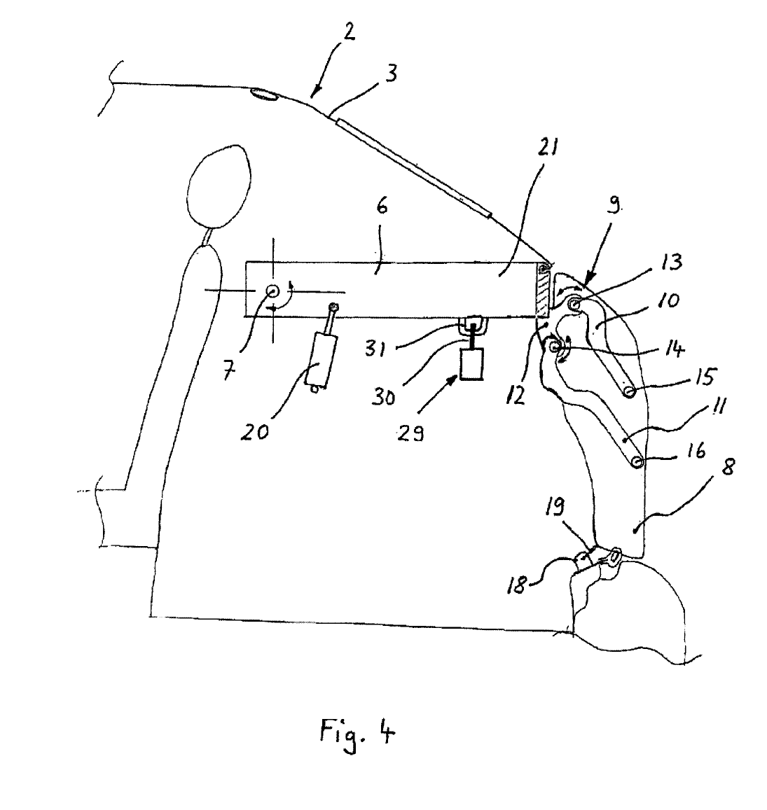

FIG. 4 is a view analogous to FIG. 1, of the rear region of the vehicle with the rear flap in the closed position, wherewith the material-tensioning bow has been provided with an alternative locking mechanism.

A vehicle 1, e.g. a “hatchback convertible” (having a folding top and an up-swingable rear flap door which covers the rear opening of the rear storage space of the vehicle), has a retractable or folding top 2 which is adjustable in known fashion between a closed position over a passenger compartment and an open position in which it is folded up and stowed in the rear part of the vehicle. The covering material 3 of the folding top 2 has a rear window 4 in its rear region, and when the top is in the closed position said covering material 3 is held under tension, over at least one slat 5 which may be associated with an upright support member, and over a rear material-tensioning bow 6 which forms the structural rear terminus of the folding top 2. The essentially U-shaped bow 6 is swingably mounted to be swingable around a swing axis 7 at its vehicle-body end, by means of swing bearings disposed on the two sides of the vehicle. Such a material-tensioning bow is known from, e.g., DE 4123283 A1, DE 4441666 C1, and (alternatively) EP 0749859 B1.

A rear flap door 8 of the vehicle 1 is swingably mounted on the material-tensioning bow 6 by means of a support apparatus 9. The support apparatus 9 may be in the form of, e.g., a quadruple hinge mechanism with an upper link rod 10 and a lower link rod 11, which rods are articulatedly mounted to a rear part of the material-tensioning bow 6 or to a support member 12 fixed to said bow, with articulation occurring at swing axes 13 and 14; and said rods (10, 11) are also articulatedly mounted to the rear flap 8 at swing axes 15 and 16. The support apparatus 9 essentially comprises two quadruple joint mechanisms (of which only one is illustrated in the Figures); alternatively it may comprise only a single quadruple joint mechanism which is centrally located.

For locking the rear flap door 8, a door lock 18 is provided at the lower edge 17 of said rear flap door, wherewith the bolt member may be disposed on the vehicle body and the latch member on the rear flap 8, or the bolt member may be disposed on the rear flap 8 and the latch member on the vehicle body. Closure assist means 19 for the rear flap 8 may also be provided, on the vehicle body or on the rear flap 8.

The material-tensioning bow 6 is swingable by means of a swinging device 20, comprising, e.g., a hydraulic cylinder or a direct drive motor, which is braced against the vehicle body. The swinging device 20 may be, or may employ, a pressurized gas cylinder, for providing support for the weight of the material-tensioning bow 6 and the rear flap 8 borne on the bow 6, and to facilitate manual actuation or swinging of the bow 6.

The rear flap door 8 has a swing arm 21 which extends forwardly (e.g. forwardly with an upward incline) from the support apparatus 9 when the rear flap 8 is closed (FIG. 1). A tensile cable 22 is attached to the forward end of the swing arm 21; the opposite end of cable 22 is connected to a part of the vehicle body 23, e.g. via a tensile spring 24. The swing arm 21 may be configured as an extension of the lower link rod 11 of the quadruple hinge mechanism, extending generally forward beyond the swing axis 14.

Additional locking means may be provided by a pin 25 which is mounted on the vehicle body (or on a part attached to the vehicle body), wherewith when the rear flap 8 is swung closed a latch finger 26 (disposed e.g. on the lower link rod 11) engages the pin 25.

To provide access to a loading opening 27 of the rear storage space 28, the rear flap lock 18 is released and the rear flap 8 is swung upward out of its closed position (movement from the position of FIG. 1 to that of FIG. 2). In the process, the latch finger 26 disengages from the pin 25, and the tension on the tensile cable 22 is released. The maximum achievable height of the loading opening as a result of this up-swinging is indicated by “x₁” in FIG. 2.

Starting with the position illustrated in FIG. 2, the rear flap 8 can be raised further, along with the material-tensioning bow 6, by swinging the bow 6 upward around the swing axis 7. With the system in the maximally raised position illustrated in FIG. 3, the accessible height of the loading opening has been increased (to x₂).

When the rear flap 8 is closed (from the position of FIG. 3 to that of FIG. 1), during the latter part of the movement the flap 8 re-engages and becomes locked by the rear flap door lock 18 (possibly with the assistance of the closure assist device 19), and the tensile cable 22 is again placed under tension, wherewith in the final position according to FIG. 1 the top bow 6 is held locked in its closed position. The arrangement is such that whenever the rear flap 8 is closed it reliably engages the lock 18. (The locking via the pin 25 is supplemental to locking with the lock 18, or possibly may be an alternative to it.)

According to an alternative configuration illustrated in FIG. 4, the material-tensioning bow 6 is moved into its closed position by the swinging device 20, where it engages a lock 29 provided on the left or right side. The lock 29 has a catch or latch member 30 which lockingly engages a yoke 31 on the material-tensioning bow 6. The lock 29 is unlocked (automatically), e.g. when the swinging device 20 is actuated, via a suitably coupled unlocking device.

A closure assist device of some kind may also be provided to assist in locking the material-tensioning bow 6 or may serve as an alternative for locking the bow 6 in place of the lock 29, the pin 25, the tensile cable 22, or the like; this device may be associated with, e.g., the rear flap door lock 18, and may have a relatively long closure excursion of several centimeters. When such a device is employed, when the rear flap 8 is closed the said bow closure assist device brings the material-tensioning bow 6 into its locked position and in the process the bow 6 comes to be held by the rear flap door lock 18.

The rear flap door may have a low-weight construction, e.g. LFI (long fiber injection), PHC (paper honeycomb), WHC (Webasto honeycomb), SMC (sheet molded compound) (aka sheet molding compound), or LFT (long fiber thermoplastic), thereby reducing the weight of the structure which must be supported and to which a force moment must be applied in the up-swinging and raising. Examples of lightweight vehicle parts are provided in EP 0995667 A1, DE 2934430 A1, and DE 100332332 C2. The described structures and modes of manufacture are suitable for the present rear flap door 8.

### List of Reference Numerals

1 vehicle.
2 folding top (or retractable top).
3 covering material.
4 rear window.
5 slat.
6 material-tensioning bow.
7 swing axis.
8 rear flap door (e.g. hatchback).
9 support apparatus.
10 upper link rod.
11 lower link rod.
12 support member.
13 swing axis.
14 swing axis.
15 swing axis.
16 swing axis.
17 lower edge.
18 rear flap lock.
19 closure assist device.
20 swinging device.
21 swing arm.
22 tensile cable.
23 part of vehicle body.
24 tensile spring.
25 pin.
26 latch finger.
27 loading opening.
28 rear storage space.
29 lock.
30 catch or latch member.
31 yoke.

1. A vehicle with a folding convertible top which is adjustable between a closed position and an open position and which has a movable rear “top bow” member and a rear flap door, which rear flap door closes off a rear storage space; characterized in that the rear flap door is swingably mounted on the top bow member.

2. A vehicle of claim 1;
characterized in that, to render accessible an enlarged rear loading opening, the rear flap door can be raised along with the upwardly swingable top bow.

3. A vehicle of claim 1;
characterized in that the rear flap door is swingably mounted on the top bow by means of a support apparatus, which support apparatus is comprised of a hinge mechanism, a multi-hinge mechanism, or in particular a quadruple hinge mechanism.

4. A vehicle claim 1;
characterized in that the top bow is connected to the vehicle body via a pressurized gas cylinder (so-called “pneumatic spring”).

5. A vehicle of claim 1;
characterized in that the top bow is swingable by means of a swinging device, which may comprise a hydraulic cylinder or a motor-driven drive.

6. A vehicle of claim 1;
characterized in that the top bow is in the form of a material-tensioning bow associated with the folding convertible top which top has covering material.

7. A vehicle of claim 1;
characterized in that, when the rear flap door is closed, a tensile device which connects the rear flap door with the vehicle body is active, serving to hold the top bow (material-tensioning bow) in its closed position.

8. A vehicle of claim 7;
characterized in that the tensile device is (or becomes) inactive when the rear flap door is swung upward.

9. A vehicle of claim 7;
characterized in that the tensile device comprises a tensile cable which is attached to a swing arm which is robustly connected to the rear flap door; and in that the swing arm is mounted on the rear flap door in a manner such that when the rear flap door is swung upward the tensile cable is relaxed from its tensile active condition and allows up-swinging of the top bow (material-tensioning bow).

10. A vehicle of claim 9;
characterized in that the tensile cable is connected to the vehicle body via a tensioning spring.

11. A vehicle of claim 1;
characterized in that, when the rear flap door is swung into its closed position, a locking member of the rear flap door, which locking member is disposed near the swinging support apparatus of the rear flap door, comes into locking engagement with a holding member which is connected to the vehicle body.

12. A vehicle of claim 1;
characterized in that a door lock is provided for the rear flap door, which lock has associated with it a closure assist device.

13. A vehicle of claim 1;
characterized in that the closure assist device serves to lock the top bow (material-tensioning bow) in its closed position, and the excursion of the closure assist device is relatively large.

14. A vehicle of claim 1;
characterized in that the top bow (material-tensioning bow) is lockable to the vehicle body by at least one lock means.

15. A vehicle of claim 1;
characterized in that, when the rear flap door is in its closed position, it is generally vertically oriented, and closes-off the rear loading opening.

16. A vehicle of claim 1;
characterized in that the rear flap door is of lightweight construction.

17. A vehicle of claim 1;
characterized in that the vehicle is a “hatchback convertible”, and the rear flap door immediately adjoins the top bow (material-tensioning bow).
